(19) United States
(12) Patent Application Publication
(10) Pub. No.: US 2024/0062570 A1
(43) Pub. Date: Feb. 22, 2024

(54) DETECTING UNICODE INJECTION IN TEXT

(71) Applicant: International Business Machines Corporation, Armonk, NY (US)

(72) Inventors: Zhong Fang Yuan, Xi'an (CN); Tong Liu, Xi'an (CN); Ting Ting Cao, Beijing (CN); Hai Bo Zou, Beijing (CN); Xiang Yu Yang, Xi'an (CN)

(21) Appl. No.: 17/891,613

(22) Filed: Aug. 19, 2022

(51) Int. Cl. G06V 30/19; G06F 40/40; G06F 40/279

(52) U.S. Cl. CPC G06V 30/19173; G06V 30/19147; G06F 40/40; G06F 40/279

(57) ABSTRACT

A computer-implemented method, system and computer program product for detecting Unicode injection in text. A language model is trained to determine if text data (e.g., text fragment) conforms with human writing habits using negative and positive samples. Negative samples include samples of text that are not classified as being suspect for containing Unicode characters. Such negative samples include text written by humans. Positive samples include samples of text that are to be classified as being suspect for containing Unicode characters. Such positive samples may be formed by randomly inserting Unicode characters into the corpus of negative samples. After training the language model, the language model is able to determine whether the received text data (e.g., text fragment) is suspect for containing Unicode characters based on whether the text data conforms with human writing habits.

### TECHNICAL FIELD

The present disclosure relates generally to Unicode injection, and more particularly to detecting Unicode injection in text, including in text, such as a text training set, used by natural language processing tasks (e.g., text classification).

### BACKGROUND

Unicode injection involves the use of Unicode (an information technology standard for the consistent encoding, representation and handling of text expressed in most of the world's writing systems) in text. Such Unicode injection may be utilized to encode certain characters, such as in a URL (Uniform Resource Locator), in order to bypass filters to access restricted resources or to force browsing to protected pages. In another example, Unicode injection may be utilized to encode certain characters, such as in a text training set, so as to cause a model, such as a natural language processing model, to experience training errors.

Natural language processing is a subfield of linguistics, computer science, and artificial intelligence concerned with the interactions between computers and human language. The goal is a computer capable of “understanding” the contents of documents, including the contextual nuances of the language within them. The technology can then accurately extract information and insights contained in the documents as well as categorize and organize the documents themselves.

In natural language processing, models, such as text processing models, may be utilized to provide summarization of the main points in a given text or document, classify text according to predefined categories or classes, organize information, etc. Such models may be trained using text from a corpus of documents. However, such text may include Unicode characters to purposely encode certain characters in the text so as to cause the model to experience errors, including a failure of a natural language processing task (e.g., text classification). For example, the “/” character may be a character in the training data that is to be flagged by the auditing system so as to be modified or deleted in the training data. However, the “/” character may be encoded in Unicode as “% co % af” thereby bypassing the auditing system. Such insertion of Unicode characters is referred to as “Unicode injection.” The above example illustrates a particular type of Unicode injection which is referred to as “direct Unicode injection.”

Unicode injection may also occur by converting commonly used English letters in text, such as a text training set used by natural language processing tasks, into letters used in a different language with a similar appearance, such as Cyrillic letters. Such a type of Unicode injection is referred to as “indirect Unicode injection,” which may also cause failures of a natural language processing task.

As a result of the multiple methods of Unicode injection and the various locations in the text where such Unicode characters could be injected, it is difficult to detect and filter out such Unicode characters.

Unfortunately, there is not currently a means for detecting Unicode injection in text, including in text, such as a text training set, used by natural language processing tasks (e.g., text classification).

### SUMMARY

In one embodiment of the present disclosure, a computer-implemented method for detecting Unicode injection in text comprises training a language model to determine if text data conforms with human writing habits. The method further comprises receiving text data by the language model to determine if the text data is suspect for containing Unicode characters based on whether the text data conforms with human writing habits.

It has been discovered that text injected with Unicode characters does not conform to human writing habits. As a result, the language model is able to determine whether the received text data is suspect for containing Unicode characters based on whether the text data conforms with human writing habits. In this manner, Unicode injection, such as direct Unicode injection, is able to be detected.

Other forms of the embodiment of the computer-implemented method described above are in a system and in a computer program product.

In another embodiment of the present disclosure, a computer-implemented method for detecting Unicode injection in text comprises recording image data from a copy of original data. The method further comprises recording a first set of text data from the original data. The method additionally comprises performing optical character recognition on the recorded image data to generate a second set of text data. Furthermore, the method comprises generating a first feature vector for the first set of text data. Additionally, the method comprises generating a second feature vector for the second set of text data. In addition, the method comprises comparing the first and second feature vectors to determine if the first set of text data is suspect for containing Unicode characters.

It has been observed that the result of a natural language processing task processing text mixed with Unicode characters and processing text without Unicode characters is very different. As a result, by comparing the first and second feature vectors, such as the measurements of the first and second feature vectors, which may be generated by a pre-trained natural language processing task, Unicode injection, such as indirect Unicode injection, is able to be detected.

Other forms of the embodiment of the computer-implemented method described above are in a system and in a computer program product.

For example, in a further embodiment of the present disclosure, a computer program product for detecting Unicode injection in text, where the computer program product comprises one or more computer readable storage mediums having program code embodied therewith, where the program code comprises programming instructions for recording image data from a copy of original data. The program code further comprises the programming instructions for recording a first set of text data from the original data. The program code additionally comprises the programming instructions for performing optical character recognition on the recorded image data to generate a second set of text data. Furthermore, the program code comprises the programming instructions for generating a first feature vector for the first set of text data. Additionally, the program code comprises the programming instructions for generating a second feature vector for the second set of text data. In addition, the program code comprises the programming instructions for comparing the first and second feature vectors to determine if the first set of text data is suspect for containing Unicode characters.

It has been observed that the result of a natural language processing task processing text mixed with Unicode characters and processing text without Unicode characters is very different. As a result, by comparing the first and second feature vectors, such as the measurements of the first and second feature vectors, which may be generated by a pre-trained natural language processing task, Unicode injection, such as indirect Unicode injection, is able to be detected.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the Unicode injection detection mechanism to detect Unicode characters in text in accordance with an embodiment of the present disclosure;

FIG. 3 illustrates training a language model to recognize normal text and text containing Unicode characters based on negative and positive samples in accordance with an embodiment of the present disclosure;

FIG. 4 illustrates detecting Unicode characters injected in text by comparing feature vectors in accordance with an embodiment of the present disclosure;

FIG. 5 illustrates an embodiment of the present disclosure of the hardware configuration of the Unicode injection detection mechanism which is representative of a hardware environment for practicing the present disclosure;

FIG. 6 is a flowchart of a method for detecting Unicode injection using a language model in accordance with an embodiment of the present disclosure;

FIG. 7 is a flowchart of a method for training a language model to determine if the text data conforms with human writing habits in accordance with an embodiment of the present disclosure; and

FIG. 8 is a flowchart of a method for detecting Unicode injection using feature vectors in accordance with an embodiment of the present disclosure.

### DETAILED DESCRIPTION

As stated in the Background section, in natural language processing, models, such as text processing models, may be utilized to provide summarization of the main points in a given text or document, classify text according to predefined categories or classes, organize information, etc. Such models may be trained using text from a corpus of documents. However, such text may include Unicode characters to purposely encode certain characters in the text so as to cause the model to experience errors, including a failure of a natural language processing task (e.g., text classification). For example, the “/” character may be a character in the training data that is to be flagged by the auditing system so as to be modified or deleted in the training data. However, the “/” character may be encoded in Unicode as “% co % af” thereby bypassing the auditing system. Such insertion of Unicode characters is referred to as “Unicode injection.” The above example illustrates a particular type of Unicode injection which is referred to as “direct Unicode injection.”

Unicode injection may also occur by converting commonly used English letters in text, such as a text training set used by natural language processing tasks, into letters used in a different language with a similar appearance, such as Cyrillic letters. Such a type of Unicode injection is referred to as “indirect Unicode injection,” which may also cause failures of a natural language processing task.

As a result of the multiple methods of Unicode injection and the various locations in the text where such Unicode characters could be injected, it is difficult to detect and filter out such Unicode characters.

Unfortunately, there is not currently a means for detecting Unicode injection in text, including in text, such as a text training set, used by natural language processing tasks (e.g., text classification).

The embodiments of the present disclosure provide a means for detecting Unicode injection in text, such as text (e.g., text training set) used by natural language processing tasks, by training a language model to detect text (e.g., text fragment) that does not conform with human writing habits which indicates a Unicode injection (e.g., direct Unicode injection) as discussed further below. Alternatively, Unicode injection in text (e.g., indirect Unicode injection) may be detected by performing optical character recognition on the recorded image data of the original text data to generate a first set of text data as well as recording the original text data as a second set of text data. A feature extraction network of pre-trained natural language processing task(s) may be utilized to generate feature vectors using the first and second sets of text data. For example, a pre-trained natural language processing task (e.g., semantic matching) may generate a first feature vector for the first set of text data and a second feature vector for the second set of text data. If the difference between the measurements of such feature vectors exceeds a threshold value, then the original text data may be identified as being suspect for containing Unicode characters. A more detailed description of these and other features will be provided below.

In some embodiments of the present disclosure, the present disclosure comprises a computer-implemented method, system and computer program product for detecting Unicode injection in text. In one embodiment of the present disclosure, a language model is trained to determine if text data (e.g., text fragment) conforms with human writing habits. In one embodiment, the language model is trained using negative and positive samples. “Negative samples,” as used herein, refer to samples of text to not be classified as being suspect for containing Unicode characters. Such negative samples include text written by humans, such as obtained on Wikipedia® (online encyclopedia) or other online sources containing publicly accessible text. “Positive samples,” as used herein, refer to samples of text to be classified as being suspect for containing Unicode characters. Such positive samples may be formed by randomly inserting Unicode characters into the corpus of negative samples to form “positive samples.” Furthermore, the language model is trained to recognize one or more regions of text with Unicode characters by an entity recognition method (e.g., bidirectional encoder representations from transformers (BERT)+conditional random fields (CRF) models). After training the language model, the language model is able to determine whether the received text data (e.g., text fragment) is suspect for containing Unicode characters based on whether the text data conforms with human writing habits. It has been discovered that text injected with Unicode characters does not conform to human writing habits. As a result, the language model is able to determine whether the received text data (e.g., text fragment) is suspect for containing Unicode characters based on whether the text data conforms with human writing habits. That is, in this manner, the present disclosure is able to detect Unicode injection, such as direct Unicode injection.

In another embodiment of the present disclosure, image data from a copy of the original text data, such as text data to be processed by a pre-trained natural language processing task (e.g., text classification) is recorded or saved. For example, text data that is to be processed by a natural language processing task may be copied and then the image data may be captured from the copied data by scanning the data with an optical or electronic device. Furthermore, the original text data may be recorded or saved. Additionally, optical character recognition of the recorded image data is performed to generate text data. That is, the recorded image data is converted into machine-encoded text using optical character recognition. Feature vectors (e.g., embeddings) of the original text data and the text data generated by optical character recognition are then generated, such as by a pre-trained natural language processing task of a feature extraction network. A “feature vector,” as used herein, refers to a vector containing multiple elements about an object. In one embodiment, such feature vectors correspond to real-valued feature vectors, such as embeddings. An “embedding,” as used herein, refers to a translation of a high-dimensional vector into a low-dimensional space. A comparison between the measurements of such feature vectors may be performed to determine whether the difference exceeds a threshold value. If the difference between the measurements of such feature vectors exceeds such a threshold value, then the original text data is identified as being suspect for containing Unicode characters. It has been observed that the result of a natural language processing task processing text mixed with Unicode characters and processing text without Unicode characters is very different. As a result, by comparing the difference between the measurements of such feature vectors generated by a pre-trained natural language processing task, the present disclosure is able to detect Unicode injection, such as indirect Unicode injection.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

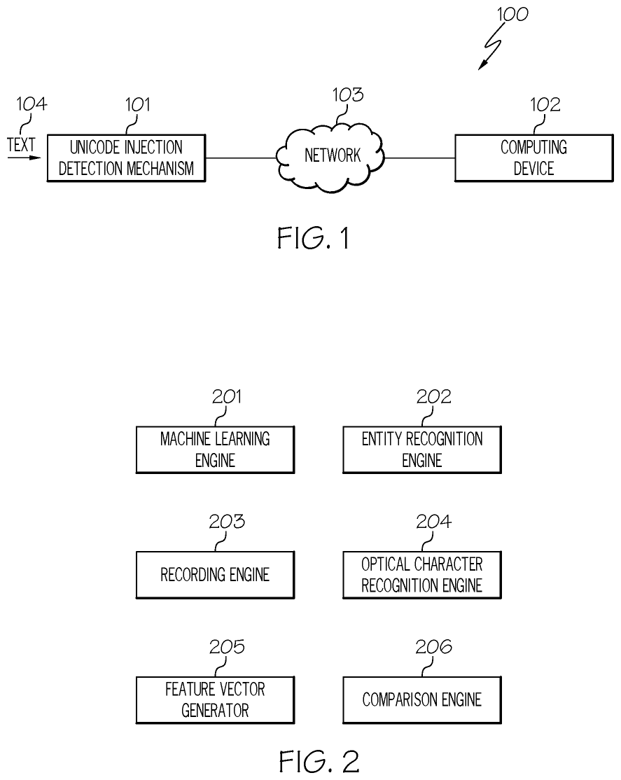

Referring now to the Figures in detail, FIG. 1 illustrates an embodiment of the present disclosure of a communication system 100 for practicing the principles of the present disclosure. Communication system 100 includes a Unicode injection detection mechanism 101 connected to a computing device 102, such as a computing device used by a natural language processing expert, via a network 103.

In one embodiment, Unicode injection detection mechanism 101 is configured to detect Unicode characters injected in text 104 (e.g., text fragment), which is received by Unicode injection detection mechanism 101, by training a language model to detect text (e.g., text fragment) that does not conform with human writing habits. It has been discovered that text injected with Unicode characters does not conform to human writing habits. For example, the phrase “% co % af,” which includes Unicode characters to encode certain characters in the text fragment, does not conform to human writing habits. As a result, in one embodiment, a language model is trained to detect text (e.g., text fragment) that does not conform with human writing habits so as to detect text (e.g., text fragment) that is suspect for containing Unicode characters. A more detailed description of these and other features is provided below.

In another embodiment, Unicode injection detection mechanism 101 is configured to detect Unicode characters injected in text 104, which is received by Unicode injection detection mechanism 101, based on the observation that the result of a natural language processing task processing text mixed with Unicode characters and processing text without Unicode characters is very different. As a result, a copy, such as a snapshot copy of the original text data to be used by a natural language processing task, is made. Such a copy retains the image archive of the original text data, which is recorded as image data. Optical character recognition is then performed on the recorded image data to generate a first set of text data. Furthermore, a second set of text data is obtained based on recording the original text data. A feature extraction network of pre-trained natural language processing task(s) may be utilized to generate feature vectors using the first and second sets of text data. For example, a pre-trained natural language processing task (e.g., semantic matching) may generate a first feature vector for the first set of text data and a second feature vector for the second set of text data. If the difference between the measurements of such feature vectors exceeds a threshold value, then the original text data may be identified as being suspect for containing Unicode characters. A more detailed description of these and other features is provided below.

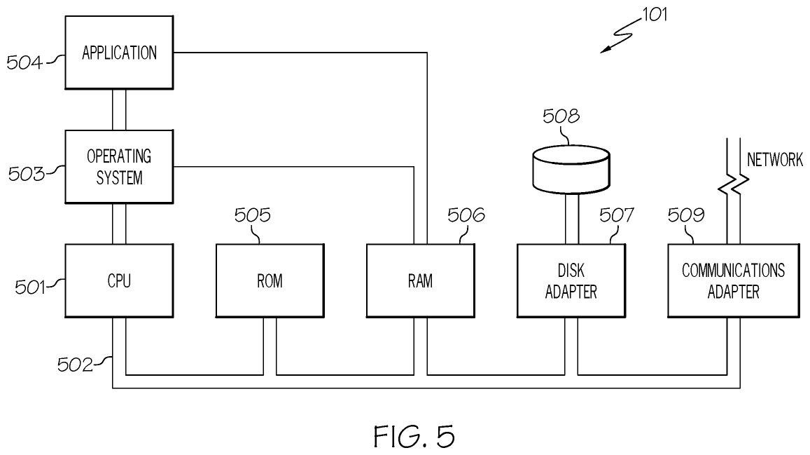

Furthermore, a description of the software components of Unicode injection detection mechanism 101 is provided below in connection with FIG. 2 and a description of the hardware configuration of Unicode injection detection mechanism 101 is provided further below in connection with FIG. 5.

Additionally, as discussed above, Unicode detection injection mechanism 101 is connected to computing device 102 via network 103. In one embodiment, when Unicode injection detection mechanism 101 identifies the text data as being suspect for containing Unicode characters, such data may be deleted by Unicode injection detection mechanism 101 or may be provided to the user of computing device 102 for further handling via network 103.

Computing device 102 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 102 (not shown) and Unicode injection detection mechanism 101. It is noted that both computing device 102 and the user of computing device 102 may be identified with element number 102.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any one particular network architecture. System 100 may include any number of Unicode injection detection mechanisms 101, computing devices 102 and networks 103.

A discussion regarding the software components used by Unicode injection detection mechanism 101 to detect Unicode characters in text is provided below in connection with FIG. 2.

FIG. 2 is a diagram of the software components of Unicode injection detection mechanism 101 to detect Unicode characters in text in accordance with an embodiment of the present disclosure.

Referring to FIG. 2, in conjunction with FIG. 1, Unicode injection detection mechanism 101 includes a machine learning engine 201 configured to train a language model using a classifier to recognize normal text and text containing Unicode characters based on negative and positive samples. In one embodiment, machine learning engine 201 receives text data conforming to human writing habits as corresponding to the “negative samples.” For example, such text data may correspond to text (e.g., documents) written by humans, such as obtained on Wikipedia® (online encyclopedia) or other online sources containing publicly accessible text. Such a corpus of documents may form the “negative samples,” where “negative samples,” as used herein, refer to samples of text to not be classified as being suspect for containing Unicode characters.

In one embodiment, machine learning engine 201 randomly inserts Unicode characters into the received text data (corpus of negative samples) to form “positive samples,” where “positive samples,” as used herein, refer to samples of text to be classified as being suspect for containing Unicode characters. In one embodiment, Unicode characters are randomly inserted in the corpus of negative samples based on randomly inserting characters obtained from a Unicode characters table, such as via the random( ) function.

In one embodiment, such negative and positive samples form the “training data,” which is used by a machine learning algorithm of machine learning engine 201, such as a classifier, to build a language model, such as a classification model, to predict or detect Unicode characters in text. The machine learning algorithm iteratively makes predictions on the training data as to whether Unicode characters are detected in the text until the predictions achieve the desired accuracy. Such a desired accuracy is determined by an expert based on the negative and positive samples of the training data. Examples of such machine learning algorithms include nearest neighbor, Naïve Bayes, decision trees, linear regression, support vector machines and neural networks.

Furthermore, in order to build a language model to accurately predict or detect Unicode characters in text, the language model is trained to recognize a region(s) of text containing Unicode characters as discussed below.

As shown in FIG. 2, Unicode injection detection mechanism 101 further includes an entity recognition engine 202 which trains the language model to recognize a region(s) of text with Unicode insertion by an entity recognition method.

In one embodiment, the entity recognition method of the present disclosure locates Unicode characters in regions of text. For example, a region of text may include normal text mixed with Unicode characters. For instance, such a region of text may include normal text that has been encoded in Unicode to bypass auditing systems.

In one embodiment, the entity recognition method utilizes an ontology containing a collection of words, terms and their interrelations, such as Unicode characters along with normal text that may be more likely to be used in connection with such Unicode characters. Such an ontology may be used by the entity recognition method to identify regions of text with Unicode insertion that matches such words, terms, etc. in the ontology. In one embodiment, such an ontology may be populated by an expert.

In one embodiment, region(s) of text containing Unicode characters are detected using the bidirectional encoder representations from transformers (BERT) model. BERT is a transformer-based machine learning technique for natural language processing. In particular, BERT is based on a multi-layer bidirectional transformer encoder, where it aims to learn deep contextual representations of words (e.g., Unicode characters surrounding a term or terms that would typically be audited by an auditing system) by pre-training on unsupervised data (e.g., candidates of text predicted by the language model as being suspect for containing Unicode characters). In one embodiment, BERT is utilized by entity recognition engine 202 to understand the meaning of ambiguous language in the text by using the surrounding text to establish context, such as the Unicode characters embedding a term or terms that would typically be audited by an auditing system.

In one embodiment, entity recognition engine 202 utilizes the BERT+CRF (conditional random fields) model to overcome the challenges of operating with low training data. CRF is a conditional probability distribution model which calculates the joint probability of a tag sequence under a given observation sequence. In one embodiment, linear-chain conditional random fields are used in the CRF model of the present disclosure.

Although BERT can learn the features of the text, it cannot model the dependencies among output tags. As a result, in one embodiment, the dependencies among the tags are modeled using CRF. Consequently, the BERT+CRF model can learn the features of text via BERT and obtain sequence-level tag information via a CRF layer. In one embodiment, the CRF layer has a transition matrix as parameters. With such a layer, the surrounding tags are used to predict the current tag.

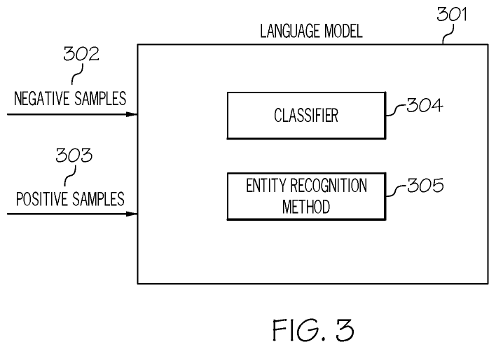

An illustration of training a language model using the classifier and entity recognition method discussed above is provided in FIG. 3.

FIG. 3 illustrates training a language model 301 to recognize normal text and text containing Unicode characters based on negative and positive samples in accordance with an embodiment of the present disclosure.

As shown in FIG. 3, language model 301 is trained by machine learning engine 201 (FIG. 2) using negative samples 302 and positive samples 303 by classifier 304 as discussed above. In one embodiment, in order to improve the recall rate of positive samples by language model 301, the number of positive samples 303 exceeds the number of negative samples 302 used to train language model 301. “Recall rate,” as used herein, refers to the number of correct results divided by the number of correct results that should have been returned.

Furthermore, as shown in FIG. 3, language model 301 uses an entity recognition method 305 to assist in recognizing a region(s) of text containing Unicode characters thereby improving the ability of language model 301 to determine whether the text data (e.g., text fragment, such as text 104) is suspect for containing Unicode characters based on whether the text data (e.g., text fragment, such as text 104) conforms with human writing habits.

As discussed above, in another embodiment, Unicode injection detection mechanism 101 is configured to detect Unicode characters injected in text 104, which is received by Unicode injection detection mechanism 101, based on the observation that the result of a natural language processing task processing text mixed with Unicode characters and processing text without Unicode characters is very different. Such an embodiment is discussed below in connection with FIG. 2.

Returning to FIG. 2, in conjunction with FIG. 1, Unicode injection detection mechanism 101 includes a recording engine 203 configured to record image data and text data as discussed below.

In one embodiment, recording engine 203 copies data (e.g., text data) that is to be processed by a natural language processing task (e.g., text classification, entity recognition, machine reading comprehension, semantic matching, machine translation, etc.). In one embodiment, recording engine 203 uses various software tools to perform a snapshot copy of the data to be processed by a natural language processing task, such as, but not limited to, IBM Spectrum® Copy Data Management, Fivetran®, Copy Handler, Catalogic® ECX, etc.

The image data from the copied data is then recorded or saved by recording engine 203. For example, the image data is captured from the copied data by scanning the data with an optical or electronic device (e.g., scanner). Such image data is then recorded or saved as image data, such as being saved in a storage device (e.g., memory, disk unit) of Unicode injection detection mechanism 101.

In one embodiment, recording engine 203 records or saves the original text data, such as in a storage device (e.g., memory, disk unit) of Unicode injection detection mechanism 101.

Furthermore, Unicode injection detection mechanism 101 includes an optical character recognition engine 204 configured to convert the recorded image data into machine-encoded text. That is, optical character recognition engine 204 perform optical character recognition of the recorded image data to generate text data. Examples of optical character recognition software utilized by optical character recognition engine 204 to perform such optical character recognition include, but not limited to, Nanonets, OmniPage® Ultimate, Rossum®, DEVONthink® Pro, IBM® Datacap, Docparser, Veryfi, Hypatos®, etc.

Additionally, Unicode injection detection mechanism 101 includes a feature vector generator 205 configured to generate feature vectors of the text data generated by optical character recognition engine 204 as well as the original text data. Since the image data and the text data should have a one-to-one correspondence, the text data generated by optical character recognition engine 204 and the original text data should also have a one-to-one correspondence unless the original text data contains Unicode characters. To determine if that is the case, in one embodiment, feature vector generator 205 uses a feature extraction network of pre-trained natural language processing tasks (e.g., text classification, entity recognition, machine reading comprehension, semantic matching, machine translation, etc.) to generate feature vectors of the text generated by optical character recognition engine 204 and the original text data. A “feature vector,” as used herein, refers to a vector containing multiple elements about an object.

In one embodiment, such feature vectors correspond to real-valued feature vectors, such as embeddings. An “embedding,” as used herein, refers to a translation of a high-dimensional vector into a low-dimensional space. In one embodiment, the embedding captures the semantics of the input (text data) by placing semantically similar inputs close together in the embedding space. In one embodiment, such embeddings are generated by the feature extraction network using models, such as the neural-net language model, Word2vec model, etc.

In one embodiment, such feature vectors generated by the feature extraction network are then compared by a comparison engine 206 of Unicode injection detection mechanism 101 to determine if the difference between the measurements of such feature vectors (feature vectors generated by a pre-trained natural language processing task for the original text data and the text data generated by optical character recognition engine 204) exceeds a threshold value, which may be user-designated. If the difference between the measurements of such feature vectors exceeds such a threshold value, then comparison engine 206 identifies the original text data as being suspect for containing Unicode characters. Otherwise, the original text data is identified as being normal.

In one embodiment, comparison engine 206 uses cosine similarity to measure the similarity between the two feature vectors (feature vectors generated by a pre-trained natural language processing task for the original text data and the text data generated by optical character recognition engine 204). In particular, in one embodiment, comparison engine 206 uses cosine similarity to measure the similarity between the two feature vectors of an inner product space. In one embodiment, the measurement is the cosine of the angle between the two vectors which determines whether the two vectors are pointing in roughly the same direction. If the measurement exceeds a threshold value, which may be user-designated, then comparison engine 206 identifies the original text data as being suspect for containing Unicode characters. Otherwise, the original text data is identified as being normal.

Alternatively, in one embodiment, comparison engine 206 calculates the Euclidean distance between the feature vectors to measure the similarity between the two feature vectors. In one embodiment, the Euclidean distance is calculated as the square root of the sum of the squared differences between the two feature vectors. If the distance exceeds a threshold value, which may be user-designated, then comparison engine 206 identifies the original text data as being suspect for containing Unicode characters. Otherwise, the original text data is identified as being normal.

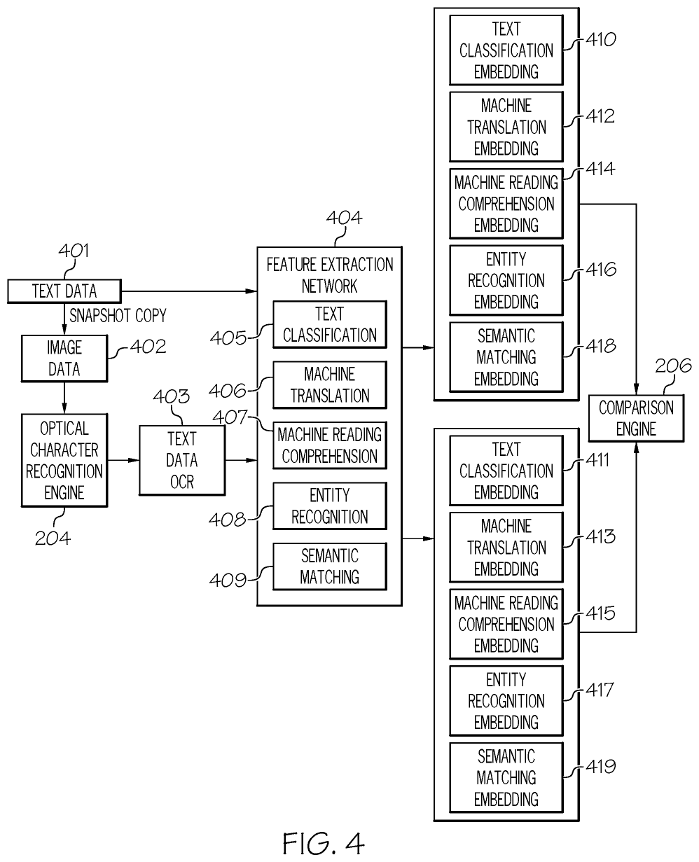

An illustration of detecting Unicode characters injected in text 104 by comparing feature vectors is discussed below in connection with FIG. 4.

FIG. 4 illustrates detecting Unicode characters injected in text 104 by comparing feature vectors in accordance with an embodiment of the present disclosure.

As shown in FIG. 4, the image data 402 captured from a snapshot copy of the original text data 401, such as text 104 of FIG. 1, is converted into text data 403 (“Text Data OCR”) by optical character recognition (OCR) engine 204 performing optical character recognition on image data 402.

Furthermore, as shown in FIG. 4, the original text data 401 and the text data 403 generated by optical character recognition engine 204 are fed into a feature extraction network 404 of one or more pre-trained natural language processing tasks, such as text classification 405, machine translation 406, machine reading comprehension 407, entity recognition 408, and semantic matching 409.

Furthermore, as shown in FIG. 4, one or more of the pre-trained natural language processing tasks of feature extraction network 404 generate feature vectors corresponding to embeddings. For example, text classification 405 generates a text classification embedding 410 for the original text data 401 and generates a text classification embedding 411 for text data 403. In another example, machine translation 406 generates a machine translation embedding 412 for the original text data 401 and generates a machine translation embedding 413 for text data 403. In a further example, machine reading comprehension 407 generates a machine reading comprehension embedding 414 for the original text data 401 and generates a machine reading comprehension embedding 415 for text data 403. In another example, entity recognition 408 generates an entity recognition embedding 416 for the original text data 401 and generates an entity recognition embedding 417 for text data 403. In a further example, semantic matching 409 generates a semantic matching embedding 418 for the original text data 401 and generates a semantic matching embedding 419 for text data 403.

In one embodiment, text data 401 and text data 403 are passed through multiple natural language processing tasks, such as natural language processing tasks 405-409, at the same time.

In one embodiment, each set of embeddings generated by a particular pre-trained natural language processing task may then be compared to determine if the difference between the measurements of such feature vectors (feature vectors generated by a pre-trained natural language processing task for the original text data and the text data generated by optical character recognition engine 204) exceeds a threshold value as discussed below.

For example, embeddings 410, 411 may be compared by comparison engine 206 to determine if the difference between the measurements of such feature vectors (feature vectors generated by a pre-trained natural language processing task for the original text data and the text data generated by optical character recognition engine 204) exceeds a threshold value, which may be user-designated. If the difference between the measurements of such feature vectors exceeds such a threshold value, then comparison engine 206 identifies the original text data 401, such as text 104 of FIG. 1, as being suspect for containing Unicode characters. Otherwise, the original text data 401, such as text 104, is identified as being normal.

A further description of these and other functions is provided below in connection with the discussion of the method for detecting Unicode injection in text.

Prior to the discussion of the method for detecting Unicode injection in text, a description of the hardware configuration of Unicode injection detection mechanism 101 (FIG. 1) is provided below in connection with FIG. 5.

Referring now to FIG. 5, FIG. 5 illustrates an embodiment of the present disclosure of the hardware configuration of Unicode injection detection mechanism 101 (FIG. 1) which is representative of a hardware environment for practicing the present disclosure.

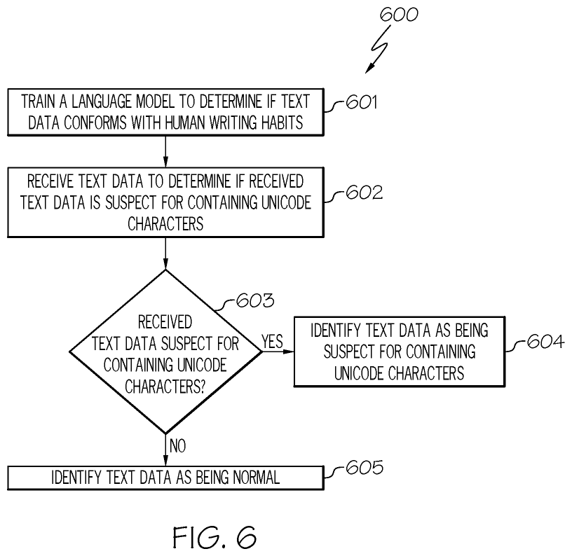

Unicode injection detection mechanism 101 has a processor 501 connected to various other components by system bus 502. An operating system 503 runs on processor 501 and provides control and coordinates the functions of the various components of FIG. 5. An application 504 in accordance with the principles of the present disclosure runs in conjunction with operating system 503 and provides calls to operating system 503 where the calls implement the various functions or services to be performed by application 504. Application 504 may include, for example, machine learning engine 201 (FIG. 2), entity recognition engine 202 (FIG. 2), recording engine 203 (FIG. 2), optical character recognition engine 204 (FIG. 2), feature vector generator 205 (FIG. 2) and comparison engine 206 (FIG. 2). Furthermore, application 504 may include, for example, a program for detecting Unicode injection in text, as discussed further below in connection with FIGS. 6-8.

Referring again to FIG. 5, read-only memory (“ROM”) 505 is connected to system bus 502 and includes a basic input/output system (“BIOS”) that controls certain basic functions of Unicode injection detection mechanism 101. Random access memory (“RAM”) 506 and disk adapter 507 are also connected to system bus 502. It should be noted that software components including operating system 503 and application 504 may be loaded into RAM 506, which may be Unicode injection detection mechanism's 101 main memory for execution. Disk adapter 507 may be an integrated drive electronics (“IDE”) adapter that communicates with a disk unit 508, e.g., disk drive. It is noted that the program for detecting Unicode injection in text, as discussed further below in connection with FIGS. 6-8, may reside in disk unit 508 or in application 504.

Unicode injection detection mechanism 101 may further include a communications adapter 509 connected to bus 502. Communications adapter 509 interconnects bus 502 with an outside network (e.g., network 103 of FIG. 1) to communicate with other devices, such as computing device 102 (FIG. 1).

In one embodiment, application 504 of Unicode injection detection mechanism 101 includes the software components of machine learning engine 201, entity recognition engine 202, recording engine 203, optical character recognition engine 204, feature vector generator 205 and comparison engine 206. In one embodiment, such components may be implemented in hardware, where such hardware components would be connected to bus 502. The functions discussed above performed by such components are not generic computer functions. As a result, Unicode injection detection mechanism 101 is a particular machine that is the result of implementing specific, non-generic computer functions.

In one embodiment, the functionality of such software components (e.g., machine learning engine 201, entity recognition engine 202, recording engine 203, optical character recognition engine 204, feature vector generator 205 and comparison engine 206) of Unicode injection detection mechanism 101, including the functionality for detecting Unicode injection in text, may be embodied in an application specific integrated circuit.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, in natural language processing, models, such as text processing models, may be utilized to provide summarization of the main points in a given text or document, classify text according to predefined categories or classes, organize information, etc. Such models may be trained using text from a corpus of documents. However, such text may include Unicode characters to purposely encode certain characters in the text so as to cause the model to experience errors, including a failure of a natural language processing task (e.g., text classification). For example, the “I” character may be a character in the training data that is to be flagged by the auditing system so as to be modified or deleted in the training data. However, the “I” character may be encoded in Unicode as “% co % af” thereby bypassing the auditing system. Such insertion of Unicode characters is referred to as “Unicode injection.” The above example illustrates a particular type of Unicode injection which is referred to as “direct Unicode injection.” Unicode injection may also occur by converting commonly used English letters in text, such as a text training set used by natural language processing tasks, into letters used in a different language with a similar appearance, such as Cyrillic letters. Such a type of Unicode injection is referred to as “indirect Unicode injection,” which may also cause failures of a natural language processing task. As a result of the multiple methods of Unicode injection and the various locations in the text where such Unicode characters could be injected, it is difficult to detect and filter out such Unicode characters. Unfortunately, there is not currently a means for detecting Unicode injection in text, including in text, such as a text training set, used by natural language processing tasks (e.g., text classification).

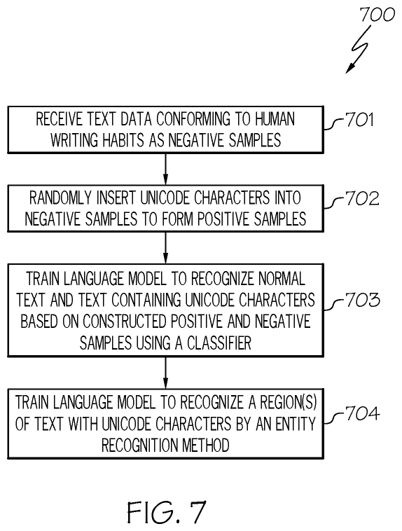

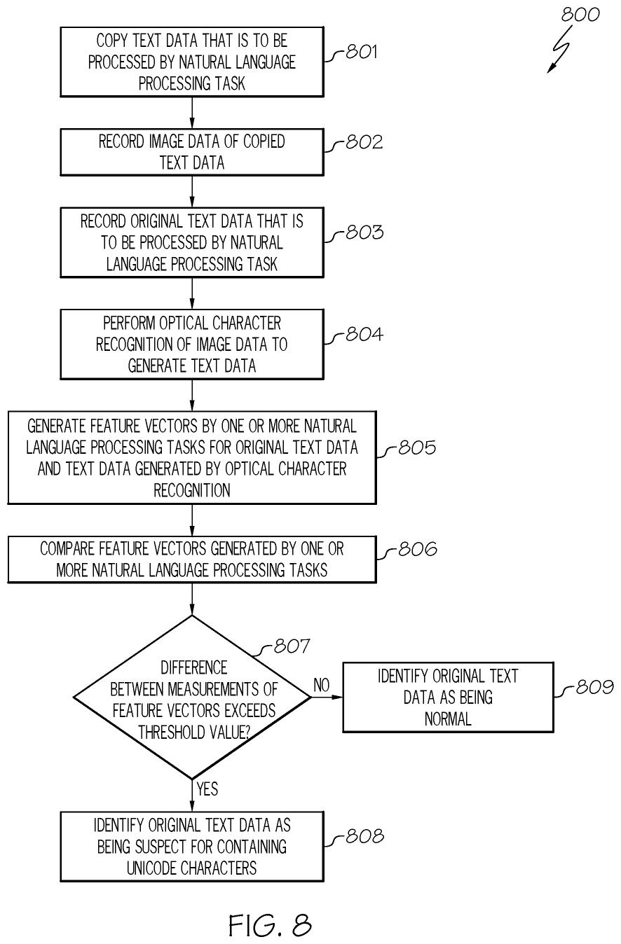

The embodiments of the present disclosure provide a means for detecting Unicode injection in text, such as text used by natural language processing tasks, by training a language model to detect text (e.g., text fragment) that does not conform with human writing habits which indicates a Unicode injection as discussed below in connection with FIGS. 6-7. Alternatively, Unicode injection in text may be detected using feature vectors as discussed below in connection with FIG. 8. FIG. 6 is a flowchart of a method for detecting Unicode injection using a language model. FIG. 7 is a flowchart of a method for training a language model to determine if the text data (e.g., text fragment) conforms with human writing habits. FIG. 8 is a flowchart of a method for detecting Unicode injection using feature vectors.

As stated above, FIG. 6 is flowchart of a method 600 for detecting Unicode injection using a language model in accordance with an embodiment of the present disclosure.

Referring to FIG. 6, in conjunction with FIGS. 1-3 and 5, in operation 601, machine learning engine 201 of Unicode injection detection mechanism 101 trains a language model, such as language model 301, to determine if text data conforms with human writing habits.

In one embodiment, machine learning engine 201 trains language model 301 to determine if text data (e.g., text fragment) conforms with human writing habits as discussed below in connection with FIG. 7.

FIG. 7 is a flowchart of a method 700 for training a language model, such as language model 301, to determine if text data (e.g., text fragment) conforms with human writing habits in accordance with an embodiment of the present disclosure.

Referring to FIG. 7, in conjunction with FIGS. 1-3 and 5-6, in operation 701, machine learning engine 201 of Unicode injection detection mechanism 101 receives text data conforming to human writing habits as corresponding to the “negative samples” 302. For example, such text data may correspond to text (e.g., documents) written by humans, such as obtained on Wikipedia® (online encyclopedia) or other online sources containing publicly accessible text. Such a corpus of documents may form the “negative samples” 302, where “negative samples,” as used herein, refer to samples of text to not be classified as being suspect for containing Unicode characters.

In operation 702, machine learning engine 201 of Unicode injection detection mechanism 101 randomly inserts Unicode characters into the received text data (corpus of negative samples) to form “positive samples” 303, where “positive samples” 303, as used herein, refer to samples of text to be classified as being suspect for containing Unicode characters.

As discussed above, in one embodiment, Unicode characters are randomly inserted in the corpus of negative samples based on randomly inserting characters obtained from a Unicode characters table, such as via the random( ) function.

In operation 703, machine learning engine 201 of Unicode injection detection mechanism 101 trains language model 301 to recognize normal text and text containing Unicode characters based on the constructed positive and negative samples 303, 302 using a classifier.

As stated above, in one embodiment, such negative and positive samples 302, 303 form the “training data,” which is used by a machine learning algorithm of machine learning engine 201, such as classifier 304, to build language model 301, such as a classification model, to predict or detect Unicode characters in text. The machine learning algorithm iteratively makes predictions on the training data as to whether Unicode characters are detected in the text until the predictions achieve the desired accuracy. Such a desired accuracy is determined by an expert based on the negative and positive samples of the training data. Examples of such machine learning algorithms include nearest neighbor, Naïve Bayes, decision trees, linear regression, support vector machines and neural networks.

Furthermore, in order to build language model 301 to accurately predict or detect Unicode characters in text, language model 301 is trained to recognize a region of text containing Unicode characters as discussed below in operation 704.

In one embodiment, in order to improve the recall rate of positive samples by language model 301, the number of positive samples 303 exceeds the number of negative samples 302 used to train language model 301. “Recall rate,” as used herein, refers to the number of correct results divided by the number of correct results that should have been returned.

In operation 704, entity recognition engine 202 of Unicode injection detection mechanism 101 trains language model 301 to recognize a region(s) of text with Unicode insertion by an entity recognition method.

As discussed above, in one embodiment, the entity recognition method of the present disclosure locates Unicode characters in regions of text. For example, a region of text may include normal text mixed with Unicode characters. For instance, such a region of text may include normal text that has been encoded in Unicode to bypass auditing systems.

In one embodiment, the entity recognition method utilizes an ontology containing a collection of words, terms and their interrelations, such as Unicode characters along with normal text that may be more likely to be used in connection with such Unicode characters. Such an ontology may be used by the entity recognition method to identify regions of text with Unicode insertion that matches such words, terms, etc. in the ontology. In one embodiment, such an ontology may be populated by an expert.

In one embodiment, region(s) of text containing Unicode characters are detected using the bidirectional encoder representations from transformers (BERT) model. BERT is a transformer-based machine learning technique for natural language processing. In particular, BERT is based on a multi-layer bidirectional transformer encoder, where it aims to learn deep contextual representations of words (e.g., Unicode characters surrounding a term or terms that would typically be audited by an auditing system) by pre-training on unsupervised data (e.g., candidates of text predicted by the language model, such as language model 301, as being suspect for containing Unicode characters). In one embodiment, BERT is utilized by entity recognition engine 202 to understand the meaning of ambiguous language in the text by using the surrounding text to establish context, such as the Unicode characters embedding a term or terms that would typically be audited by an auditing system.

In one embodiment, entity recognition engine 202 utilizes the BERT+CRF (conditional random fields) model to overcome the challenges of operating with low training data. CRF is a conditional probability distribution model which calculates the joint probability of a tag sequence under a given observation sequence. In one embodiment, linear-chain conditional random fields are used in the CRF model of the present disclosure.

Although BERT can learn the features of the text, it cannot model the dependencies among output tags. As a result, in one embodiment, the dependencies among the tags are modeled using CRF. Consequently, the BERT+CRF model can learn the features of text via BERT and obtain sequence-level tag information via a CRF layer. In one embodiment, the CRF layer has a transition matrix as parameters. With such a layer, the surrounding tags are used to predict the current tag.

After training language model 301 to determine if text data (e.g., text fragment) conforms with human writing habits, language model 301 determines if text data (e.g., text fragment) is suspect for containing Unicode characters based on whether the text data conforms with human writing habits as discussed below in connection with FIG. 6.

Returning to FIG. 6, in conjunction with FIGS. 1-3, 5 and 7, in operation 602, language model 301 receives text data (e.g., text fragment, such as text 104).

In operation 603, language model 301 determines if the received text data is suspect for containing Unicode characters as discussed above.

If language model 301 determines that the received text data (e.g., text fragment) is suspect for containing Unicode characters, then, in operation 604, language model 301 identifies the text data (e.g., text fragment, such as text 104) as being suspect for containing Unicode characters.

If, however, language model 301 does not determine that the received text data is suspect for containing Unicode characters, then, in operation 605, language model 301 identifies the text data (e.g., text fragment, such as text 104) as being normal.

In this manner, Unicode injection, such as direct Unicode injection, is able to be detected.

In an alternative embodiment, Unicode injection detection mechanism 101 detects Unicode characters in text using feature vectors as discussed below in connection with FIG. 8.

FIG. 8 is a flowchart of a method 800 for detecting Unicode injection using feature vectors in accordance with an embodiment of the present disclosure.

Referring to FIG. 8, in conjunction with FIGS. 1-2 and 4-5, in operation 801, recording engine 203 of Unicode injection detection mechanism 101 copies text data (e.g., text data 401, such as text 104) that is to be processed by a natural language processing task (e.g., text classification 405, machine translation 406, machine reading comprehension 407, entity recognition 408, semantic matching 409, etc.).

As discussed above, in one embodiment, recording engine 203 uses various software tools to perform a snapshot copy of the data to be processed by a natural language processing task, such as, but not limited to, IBM Spectrum® Copy Data Management, Fivetran®, Copy Handler, Catalogic® ECX, etc.

In operation 802, recording engine 203 of Unicode injection detection mechanism 101 records or saves the image data (e.g., image data 402) from the copied text data. For example, the image data is captured from the copied data by scanning the data with an optical or electronic device (e.g., scanner). Such image data is then recorded or saved as image data, such as being saved in a storage device (e.g., memory 505, disk unit 508) of Unicode injection detection mechanism 101.

In operation 803, recording engine 203 of Unicode injection detection mechanism 101 records or saves the original text data (e.g., text data 401, such as text 104), such as in a storage device (e.g., memory 505, disk unit 508) of Unicode injection detection mechanism 101.

In operation 804, optical character recognition engine 204 of Unicode injection detection mechanism 101 performs optical character recognition of the recorded image data (e.g., image data 402) to generate text data (e.g., text data 403). That is, optical character recognition engine 204 converts the recorded image data into machine-encoded text. Examples of optical character recognition software utilized by optical character recognition engine 204 to perform such optical character recognition include, but not limited to, Nanonets, OmniPage® Ultimate, Rossum®, DEVONthink® Pro, IBM® Datacap, Docparser, Veryfi, Hypatos®, etc.

In operation 805, feature vector generator 205 of Unicode injection detection mechanism 101 generates feature vectors of the text data (e.g., text data 403) generated by optical character recognition engine 204 as well as the original text data (e.g., text data 401).

As discussed above, since the image data and the text data should have a one-to-one correspondence, the text data generated by optical character recognition engine 204 and the original text data should also have a one-to-one correspondence unless the original text data contains Unicode characters. To determine if that is the case, in one embodiment, feature vector generator 205 uses a feature extraction network 404 of pre-trained natural language processing tasks (e.g., text classification 405, machine translation 406, machine reading comprehension 407, entity recognition 408, semantic matching 409, etc.) to generate feature vectors of the text (e.g., text data 403) generated by optical character recognition engine 204 and the original text data (e.g., text data 401). A “feature vector,” as used herein, refers to a vector containing multiple elements about an object.

In one embodiment, such feature vectors correspond to real-valued feature vectors, such as embeddings. An “embedding,” as used herein, refers to a translation of a high-dimensional vector into a low-dimensional space. In one embodiment, the embedding captures the semantics of the input (text data) by placing semantically similar inputs close together in the embedding space. In one embodiment, such embeddings are generated by feature extraction network 404 using models, such as the neural-net language model, Word2vec model, etc.

For example, one or more of the pre-trained natural language processing tasks of feature extraction network 404 generate feature vectors corresponding to embeddings. For instance, text classification 405 generates a text classification embedding 410 for the original text data 401 and generates a text classification embedding 411 for text data 403.

In operation 806, comparison engine 206 of Unicode injection detection mechanism 101 compares the feature vectors (e.g., embeddings 410, 411) generated by feature extraction network 404 to determine if the difference between the measurements of such feature vectors (feature vectors generated by a pre-trained natural language processing task for the original text data and the text data generated by optical character recognition engine 204) exceeds a threshold value, which may be user-designated.

In operation 807, comparison engine 206 of Unicode injection detection mechanism 101 determines whether the difference between the measurements of such feature vectors exceeds such a threshold value.

If the difference between the measurements of such feature vectors exceeds such a threshold value, then, in operation 808, comparison engine 206 of Unicode injection detection mechanism 101 identifies the original text data (e.g., text data 401, such as text 104) as being suspect for containing Unicode characters.

If, however, the difference between the measurements of such feature vectors does not exceed such a threshold value, then, in operation 809, comparison engine 206 of Unicode injection detection mechanism 101 identifies the original text data (e.g., text data 401, such as text 104) as being normal.

As discussed above, in one embodiment, comparison engine 206 uses cosine similarity to measure the similarity between the two feature vectors (feature vectors generated by a pre-trained natural language processing task for the original text data and the text data generated by optical character recognition engine 204). In particular, in one embodiment, comparison engine 206 uses cosine similarity to measure the similarity between the two feature vectors of an inner product space. In one embodiment, the measurement is the cosine of the angle between the two vectors which determines whether the two vectors are pointing in roughly the same direction. If the measurement exceeds a threshold value, which may be user-designated, then comparison engine 206 identifies the original text data (e.g., text data 401) as being suspect for containing Unicode characters. Otherwise, the original text data (e.g., text data 401) is identified as being normal.

Alternatively, in one embodiment, comparison engine 206 calculates the Euclidean distance between the feature vectors to measure the similarity between the two feature vectors. In one embodiment, the Euclidean distance is calculated as the square root of the sum of the squared differences between the two feature vectors. If the distance exceeds a threshold value, which may be user-designated, then comparison engine 206 identifies the original text data (e.g., text data 401) as being suspect for containing Unicode characters. Otherwise, the original text data (e.g., text data 401) is identified as being normal.

In this manner, Unicode injection, such as indirect Unicode injection, is able to be detected.

As a result of the foregoing, embodiments of the present disclosure provide a means for detecting Unicode injection in text, such as text (e.g., text training set) used by natural language processing tasks.

Furthermore, the principles of the present disclosure improve the technology or technical field involving Unicode injection. As discussed above, in natural language processing, models, such as text processing models, may be utilized to provide summarization of the main points in a given text or document, classify text according to predefined categories or classes, organize information, etc. Such models may be trained using text from a corpus of documents. However, such text may include Unicode characters to purposely encode certain characters in the text so as to cause the model to experience errors, including a failure of a natural language processing task (e.g., text classification). For example, the “I” character may be a character in the training data that is to be flagged by the auditing system so as to be modified or deleted in the training data. However, the “I” character may be encoded in Unicode as “% co % af” thereby bypassing the auditing system. Such insertion of Unicode characters is referred to as “Unicode injection.” The above example illustrates a particular type of Unicode injection which is referred to as “direct Unicode injection.” Unicode injection may also occur by converting commonly used English letters in text, such as a text training set used by natural language processing tasks, into letters used in a different language with a similar appearance, such as Cyrillic letters. Such a type of Unicode injection is referred to as “indirect Unicode injection,” which may also cause failures of a natural language processing task. As a result of the multiple methods of Unicode injection and the various locations in the text where such Unicode characters could be injected, it is difficult to detect and filter out such Unicode characters. Unfortunately, there is not currently a means for detecting Unicode injection in text, including in text, such as a text training set, used by natural language processing tasks (e.g., text classification).

Embodiments of the present disclosure improve such technology by training a language model to determine if text data (e.g., text fragment) conforms with human writing habits. In one embodiment, the language model is trained using negative and positive samples. “Negative samples,” as used herein, refer to samples of text to not be classified as being suspect for containing Unicode characters. Such negative samples include text written by humans, such as obtained on Wikipedia® (online encyclopedia) or other online sources containing publicly accessible text. “Positive samples,” as used herein, refer to samples of text to be classified as being suspect for containing Unicode characters. Such positive samples may be formed by randomly inserting Unicode characters into the corpus of negative samples to form “positive samples.” Furthermore, the language model is trained to recognize one or more regions of text with Unicode characters by an entity recognition method (e.g., bidirectional encoder representations from transformers (BERT)+conditional random fields (CRF) models). After training the language model, the language model is able to determine whether the received text data (e.g., text fragment) is suspect for containing Unicode characters based on whether the text data conforms with human writing habits. It has been discovered that text injected with Unicode characters does not conform to human writing habits. As a result, the language model is able to determine whether the received text data (e.g., text fragment) is suspect for containing Unicode characters based on whether the text data conforms with human writing habits. That is, in this manner, the present disclosure is able to detect Unicode injection, such as direct Unicode injection. Furthermore, in this manner, there is an improvement in the technical field involving Unicode injection.

In another embodiment of the present disclosure, image data from a copy of the original text data, such as text data to be processed by a pre-trained natural language processing task (e.g., text classification) is recorded or saved. For example, text data that is to be processed by a natural language processing task may be copied and then the image data may be captured from the copied data by scanning the data with an optical or electronic device. Furthermore, the original text data may be recorded or saved. Additionally, optical character recognition of the recorded image data is performed to generate text data. That is, the recorded image data is converted into machine-encoded text using optical character recognition. Feature vectors (e.g., embeddings) of the original text data and the text data generated by optical character recognition are then generated, such as by a pre-trained natural language processing task of a feature extraction network. A “feature vector,” as used herein, refers to a vector containing multiple elements about an object. In one embodiment, such feature vectors correspond to real-valued feature vectors, such as embeddings. An “embedding,” as used herein, refers to a translation of a high-dimensional vector into a low-dimensional space. A comparison between the measurements of such feature vectors may be performed to determine whether the difference exceeds a threshold value. If the difference between the measurements of such feature vectors exceeds such a threshold value, then the original text data is identified as being suspect for containing Unicode characters. It has been observed that the result of a natural language processing task processing text mixed with Unicode characters and processing text without Unicode characters is very different. As a result, by comparing the difference between the measurements of such feature vectors generated by a pre-trained natural language processing task, the present disclosure is able to detect Unicode injection, such as indirect Unicode injection. Furthermore, in this manner, there is an improvement in the technical field involving Unicode injection.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a computer-implemented method for detecting Unicode injection in text comprises training a language model to determine if text data conforms with human writing habits. The method further comprises receiving text data by the language model to determine if the text data is suspect for containing Unicode characters based on whether the text data conforms with human writing habits.

Furthermore, in one embodiment of the present disclosure, the method additionally comprises receiving text data conforming to human writing habits as negative samples. Additionally, the method comprises randomly inserting Unicode characters into the negative samples to form positive samples.

Additionally, in one embodiment of the present disclosure, the method further comprises training the language model to recognize normal text and text containing Unicode characters based on the negative and positive samples.

Furthermore, in one embodiment of the present disclosure, the method additionally comprises having a number of the positive samples used to train the language model exceed a number of the negative samples used to train the language model.

Additionally, in one embodiment of the present disclosure, the method further comprises training the language model to recognize one or more regions of text with Unicode characters by an entity recognition method.

Furthermore, in one embodiment of the present disclosure, the method additionally comprises having the entity recognition method use a bidirectional encoder representations from transformers model and a conditional random fields model.

Other forms of the embodiments of the method described above are in a system and in a computer program product.

Additionally, in one embodiment of the present disclosure, a computer-implemented method for detecting Unicode injection in text comprises recording image data from a copy of original data. The method further comprises recording a first set of text data from the original data. The method additionally comprises performing optical character recognition on the recorded image data to generate a second set of text data. Furthermore, the method comprises generating a first feature vector for the first set of text data. Additionally, the method comprises generating a second feature vector for the second set of text data. In addition, the method comprises comparing the first and second feature vectors to determine if the first set of text data is suspect for containing Unicode characters.

Furthermore, in one embodiment of the present disclosure, the method additionally comprises copying the original data that is to be processed by a natural language processing task. Furthermore, the method comprise recording the image data from the copy of original data that is to be processed by the natural language processing task.

Additionally, in one embodiment of the present disclosure, the method further comprises generating the first and second feature vectors by a natural language processing task.

Furthermore, in one embodiment of the present disclosure, the method additionally comprises having the natural language processing task comprise one of the following: text classification, entity recognition, machine reading comprehension, semantic matching and machine translation.

Additionally, in one embodiment of the present disclosure, the method further comprises identifying the first set of text data as being suspect for containing Unicode characters in response to a difference between measurements of the first and second features exceeding a threshold value.

Furthermore, in one embodiment of the present disclosure, the method additionally comprises identifying the first set of text data as being normal in response to a difference between measurements of the first and second features not exceeding a threshold value.

Additionally, in one embodiment of the present disclosure, the method further comprises having the original data correspond to data to be processed by a natural language processing task.

Other forms of the embodiments of the method described above are in a system and in a computer program product.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for detecting Unicode injection in text, the method comprising:
training a language model to determine if text data conforms with human writing habits; and
receiving text data by said language model to determine if said text data is suspect for containing Unicode characters based on whether said text data conforms with human writing habits.

2. The method as recited in claim 1 further comprising:
receiving text data conforming to human writing habits as negative samples; and
randomly inserting Unicode characters into said negative samples to form positive samples.

3. The method as recited in claim 2 further comprising:
training said language model to recognize normal text and text containing Unicode characters based on said negative and positive samples.

4. The method as recited in claim 3, wherein a number of said positive samples used to train said language model exceeds a number of said negative samples used to train said language model.

5. The method as recited in claim 3 further comprising;
training said language model to recognize one or more regions of text with Unicode characters by an entity recognition method.

6. The method as recited in claim 5, wherein said entity recognition method uses a bidirectional encoder representations from transformers model and a conditional random fields model.

7. A computer-implemented method for detecting Unicode injection in text, the method comprising:
recording image data from a copy of original data;
recording a first set of text data from said original data;
performing optical character recognition on said recorded image data to generate a second set of text data;
generating a first feature vector for said first set of text data;
generating a second feature vector for said second set of text data; and
comparing said first and second feature vectors to determine if said first set of text data is suspect for containing Unicode characters.

8. The method as recited in claim 7 further comprising:
copying said original data that is to be processed by a natural language processing task; and
recording said image data from said copy of original data that is to be processed by said natural language processing task.

9. The method as recited in claim 7 further comprising:
generating said first and second feature vectors by a natural language processing task.

10. The method as recited in claim 9, wherein said natural language processing task comprises one of the following: text classification, entity recognition, machine reading comprehension, semantic matching and machine translation.

11. The method as recited in claim 7 further comprising:
identifying said first set of text data as being suspect for containing Unicode characters in response to a difference between measurements of said first and second features exceeding a threshold value.

12. The method as recited in claim 7 further comprising:
identifying said first set of text data as being normal in response to a difference between measurements of said first and second features not exceeding a threshold value.

13. The method as recited in claim 7, wherein said original data corresponds to data to be processed by a natural language processing task.

14. A computer program product for detecting Unicode injection in text, the computer program product comprising one or more computer readable storage mediums having program code embodied therewith, the program code comprising programming instructions for:
recording image data from a copy of original data;
recording a first set of text data from said original data;
performing optical character recognition on said recorded image data to generate a second set of text data;
generating a first feature vector for said first set of text data;
generating a second feature vector for said second set of text data; and
comparing said first and second feature vectors to determine if said first set of text data is suspect for containing Unicode characters.

15. The computer program product as recited in claim 14, wherein the program code further comprises the programming instructions for:
copying said original data that is to be processed by a natural language processing task; and
recording said image data from said copy of original data that is to be processed by said natural language processing task.

16. The computer program product as recited in claim 14, wherein the program code further comprises the programming instructions for:
generating said first and second feature vectors by a natural language processing task.

17. The computer program product as recited in claim 16, wherein said natural language processing task comprises one of the following: text classification, entity recognition, machine reading comprehension, semantic matching and machine translation.

18. The computer program product as recited in claim 14, wherein the program code further comprises the programming instructions for:
identifying said first set of text data as being suspect for containing Unicode characters in response to a difference between measurements of said first and second features exceeding a threshold value.

19. The computer program product as recited in claim 14, wherein the program code further comprises the programming instructions for:
identifying said first set of text data as being normal in response to a difference between measurements of said first and second features not exceeding a threshold value.

20. The computer program product as recited in claim 14, wherein said original data corresponds to data to be processed by a natural language processing task.
